(19) United States
(12) Patent Application Publication
(10) Pub. No.: US 2008/0112881 A1
(43) Pub. Date: May 15, 2008

(54) Systems and methods for hydrogen loading and generation of thermal response

(76) Inventors: Andrei Lipson, Moscow (RU); Boris F. Lyakhov, Moscow (RU); Tatyana Zilov, Arad (IL); Ehud Greenspan, Emeryville, CA (US)

Correspondence Address: GREENBERG TRAURIG, LLP, ONE INTERNATIONAL PLACE, 20th FL, ATTN: PATENT ADMINISTRATOR, BOSTON, MA, 02110, US

(21) Appl. No.: 11/599,053

(22) Filed: Nov. 14, 2006

(51) Int. Cl. B29D 22/00; C01B 3/02

(52) U.S. Cl. 423/648.1; 428/34.1; 427/203; 977/742

(57) ABSTRACT

A system for hydrogen loading is provided. The system includes a substrate, such as that made from palladium, a matrix of nanotubes, for example, SWCNT, disposed on the substrate, and a coating, capable of dissociating hydrogen into its atomic form, covering the matrix of nanotubes. The presence of such a coating on the matrix of SWCNT can lead to a flux of hydrogen across the coating and facilitate loading of hydrogen into the nanotubes, when exposed to hydrogen at an appropriate effective pressure. The system may be also used to generate a thermal response.

### TECHNICAL FIELD

This invention relates to systems and methods for hydrogen loading, and more particularly, to composite materials and methods for hydrogen loading in connection with hydrogen storage and generation of a thermal response.

### BACKGROUND ART

The use of carbon nanotubes for hydrogen storage has been actively explored over the last 10 years. From these studies, it has been proposed that physisorption and chemisorption may be the mechanisms for hydrogen uptake and storage in carbon nanotubes. Based on theoretical calculations, it has been predicted that the strength of interaction between a carbon (C) atom and hydrogen (H) can vary between 0.11 eV per H₂-molecule for physisorption, and 2.5 eV per H-atom for chemisorption. In general, the physisorption mechanism involves the adsorption of molecular hydrogen inside or between the carbon nanotubes. On the other hand, the chemisorption mechanism involves dissociation of hydrogen using a catalyst that can subsequently lead to a reaction with unsaturated C—C bonds to form C—H bonds.

Presently, it is known that single wall carbon nanotubes (SWCNT) can adsorb hydrogen chemically and/or physically up to 20% by weight. This adsorption capability corresponds to a hydrogen/carbon atom ratio of x=H/C ˜3.0. Previous studies have reported hydrogen capacities for carbon nanotubes ranging from about 0.25 wt % to about 20 wt %. One reason for such a large variation in the experimental results can be due to using carbon nanotube samples containing metallic and/or other impurities (e.g., Ni, Co catalyst, amorphous carbon, water, hydrocarbons, etc.) that can influence the hydrogen adsorption. In particular, since mobility of molecular hydrogen within the SWCNT can be relatively low, the physisorption of H₂ molecules within the nanotubes can be drastically reduced by structural defects and impurities.

Another reason may be that the physical variations in the nanotubes can be considerably different between studies, leading to large systematic errors. For example, different samples can have nanotubes of different diameters, which can strongly affect hydrogen uptake performance. These factors, along with uncontrolled SWCNT length can lead to variations and inconsistencies in SWCNT loading, especially in gas phase hydrogen loading.

### SUMMARY OF THE INVENTION

The present invention is directed to, in an embodiment, a system which can be used for loading of hydrogen. The system includes a substrate, which in one embodiment, can be made from an electrically conductive material. The substrate may also have capacity for hydrogen storage and affinity to palladium. The system also includes a matrix of nanotubes, for example, SWCNT, disposed on the substrate, so as to provide an environment for which hydrogen may be directed within the nanotubes. The system can further include a coating deposited over the matrix of nanotubes. The coating, in an embodiment, may be made from a material having hydrogen solubility and diffusivity to permit subsequent migration of hydrogen into the nanotubes. In an embodiment, hydrogen solubility and diffusivity can result in dissociation of hydrogen molecules into its atomic and/or ionic form. The coating may also act to enhance retention of the matrix of nanotubes on the substrate. This coating, in one embodiment, may be disposed on or circumferentially about the nanotubes. To further enhance retention of the matrix on the substrate, the system, in an embodiment can also include a thin film deposited between the surface of the substrate and the matrix of nanotubes. In such an embodiment, the coating may be a layer deposited over the nanotubes, so that in conjunction with the thin film, the matrix of nanotubes can be sandwiched between the coating and the thin film.

The present invention also provides a method for manufacturing a system for loading of hydrogen. In an embodiment, the method includes initially providing a substrate. Next, a matrix of nanotubes, such as SWCNT, may be applied on to the substrate, such that the matrix can provide an environment wherein hydrogen can be directed within the nanotubes. Thereafter, a coating, made from a material having hydrogen solubility and diffusivity to permit subsequent migration of hydrogen into the nanotubes, may be deposited onto the matrix of nanotubes.

The present invention can further provide a method for hydrogen loading. In an embodiment, the method includes providing a matrix of nanotubes covered with a coating made from a material having hydrogen solubility and diffusivity to permit subsequent migration of hydrogen into the nanotubes. Next, a flux of hydrogen may be generated across the coating and into the nanotubes. In an embodiment, the flux may be a flux of hydrogen atoms as hydrogen may be dissociated into its atomic and/or ionic form when moving across the coating. Once within the nanotubes, the nanotube can provide an environment where hydrogen may be retained therein while they approach loading capacity of the nanotubes. In accordance with one embodiment of the present invention, the nanotubes can be loaded, beyond 4 wt %, and preferably about 10 wt % or more, with hydrogen.

The present invention further provides a method of generating a hydrogen flux. In an embodiment the method includes initially providing a matrix of nanotubes, such as SWCNT, covered with a coating made from a material having hydrogen solubility and diffusivity to permit subsequent migration of hydrogen into the nanotubes. Next, the coated matrix of nanotubes may be exposed to hydrogen in an environment having an appropriate effective pressure. Thereafter, hydrogen may be permitted to move across the coating, so that a flux of hydrogen atoms can be generated and directed into the nanotubes. In an embodiment, a flux may be generated so as to direct the hydrogen across the SWCNT in the direction of a Pd substrate, and alternatively in the opposite direction upon reduction or termination of the hydrogen loading driving force.

In accordance with another embodiment, there is provided a system for generating a thermal response. The system includes a substrate, which, in an embodiment, may be made from an electrically conductive material. The substrate may have capacity for hydrogen storage and affinity to palladium. The system also includes a matrix of nanotubes, for example, SWCNT, disposed on the substrate. The system can also include, deposited on the matrix of nanotubes, a coating made from a material having hydrogen solubility and diffusivity to permit subsequent migration of hydrogen into the nanotubes. In an embodiment, hydrogen solubility and diffusivity includes dissociation of hydrogen molecules into its atomic and/or ionic form. The system further includes an amount of hydrogen provided within the nanotubes, so as to provide an environment conducive to an exothermic reaction leading to a thermal response.

The present invention also provides a method for generating a thermal response. The method, in an embodiment, includes initially providing a matrix of nanotubes covered with a coating made from a material having hydrogen solubility and diffusivity to permit subsequent migration of hydrogen into the nanotubes. Next, hydrogen may be permitted to move across the coating, so that a flux of hydrogen atoms can be generated and directed into the nanotubes. Thereafter, in the presence of hydrogen within the nanotubes, an exothermic reaction is permitted to occur within the nanotubes to provide a thermal response.

The present invention further provides a method for hydrogen purification or filtration using the system of the present invention. In particular, the coating about the matrix of SWCNT can be utilized to allow substantially high purity hydrogen to migrate into the SWCNT, since Pd may be substantially transparent to hydrogen and not as transparent to other gases.

### BRIEF DESCRIPTION OF DRAWINGS

FIG. 1 illustrates a cross-sectional view of a system for high-density hydrogen loading and energy generation in accordance with one embodiment of the present invention.

FIG. 2 illustrates an electrolytic cell used with the present invention.

FIGS. 3-4 illustrate a time history of a thermal response in an electrolytic cell experiment using the system of the present invention.

FIG. 5 illustrates a time history of a thermal response in another electrolytic cell experiment using the system of the present invention.

### DESCRIPTION OF SPECIFIC EMBODIMENTS

In view of the limitations now present in the prior art, the present invention provides a system and method for, among other things, high-density hydrogen loading and generation of a thermal response.

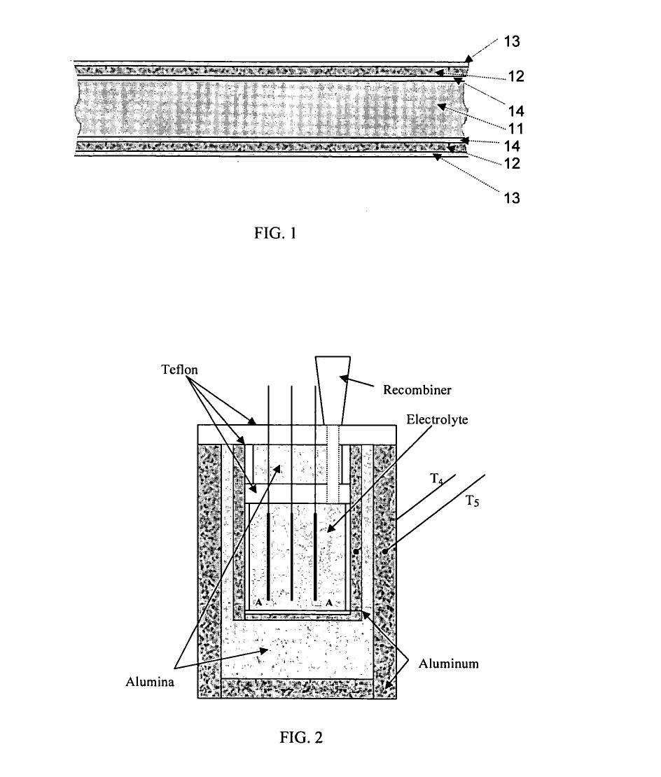

Looking now at FIG. 1, there is provided a system 10 for hydrogen loading. The system 10 of the present invention includes a composite having, in one embodiment, a substrate 11, a matrix of nanotubes 12 disposed on the substrate 11, and a coating 13 deposited on the matrix of nanotubes 12. In an embodiment, coating 13 may be made from a material having hydrogen solubility and diffusivity to permit subsequent migration of hydrogen into the nanotubes. In one embodiment, the solubility and diffusivity of the coating to hydrogen can result in dissociation of hydrogen molecules into its atomic and/or ionic form. For ease of discussion, it should be appreciated that reference made hereinafter to “hydrogen atoms” can include “hydrogen ions” or hydrogen in its ionic form. In addition, it should be appreciated that in the following discussion reference to the term hydrogen can include any hydrogen isotopes, including H, D, T, or any combination thereof.

The substrate 111 used in connection with the system 10 of the present invention, in accordance with an embodiment, may include a metallic material, for instance palladium (Pd). In one embodiment, the substrate 11 may be a palladium metal foil provided with a thickness of approximately 50 micron. The substrate 11, of course, can have other forms, for instance, a mesh having various thicknesses. By utilizing a mesh of Pd, the substrate 11 may be provided with an active surface area substantially larger than that of a foil. In addition, the substrate 11 may be provided with any dimensions and/or geometric shapes, so long as substrate 11 includes a surface upon which nanotubes 12 can be deposited.

The substrate 11 can also be made from any other suitable materials. These materials may include metals, metal alloys or solids that can provide sufficiently high electrical conductivity. For certain applications, in an embodiment, it may not be necessary to have the substrate made from an electrically conductive material.

Additionally, for other certain applications, it may be advantageous to have substrate 11 made from a material that has a relatively large capacity for hydrogen storage and that can absorb and desorb hydrogen relatively quickly. Such a material should also have an affinity to Pd, so as to enable electrodeposition of, for example, Pd or Pd alloys thereon. Examples of suitable alternative materials, of which there are many, include, copper (Cu), silver (Ag), titanium (Ti), zirconium (Zr), Pd alloys, such as PdAg or Pd Rh, or a combination thereof.

With respect to the matrix of nanotubes 12 employed in connection with the system 10 of the present invention, the nanotubes 12 may include, in an embodiment, Single Wall Carbon Nanotubes (SWCNT). However, it should be appreciated that nanotubes 12 or nano-cavities having different shapes, cross-sections, and/or sizes, and made from materials other than carbon can also be used. For example, depending on the application, nanotubes 12 having different diameter sizes may be used. In an embodiment, nanotubes having relatively small diameters may be employed since a relatively small diameter can provide, for instance, tighter hydrogen binding, as compared to nanotubes with larger diameters. Nevertheless, in terms of hydrogen loading, nanotubes 12 of any diameter that can allow hydrogen to be stored or retained at room temperature may be used. In certain other applications, nanotubes 12 that can permit hydrogen to desorb at temperature greater than room temperature, for example, T>50° C., may be used.

In addition, since the length of the nanotubes 12, as well as their aggregation, can affect attainable hydrogen density and mobility, the length and/or aggregation of the nanotubes 12 may also be varied, so long as the desired hydrogen loading capacity and mobility can be achieved.

As for the coating 13, it may be applied over the matrix of nanotubes 12. In one embodiment, in addition to allowing hydrogen to be soluble and diffusible therethrough, coating 13 may also act to enhance retention of the matrix of nanotubes 12 on the substrate 11. The coating 13, in an embodiment, may be made from a metallic material, for instance Pd or its alloys, such as PdAg, PdRh, among others, or a combination thereof. It should be appreciated that any material that can provide a robust layer, that does not chip off easily, and/or that has hydrogen solubility and diffusivity to permit subsequent migration of hydrogen into the nanotubes can also be used to form the coating 13. In one embodiment, and as described in more detail below, the coating 13 may be provided as a layer or coating upon or circumferentially about the matrix of nanotubes 12. Alternatively, the coating 13 may be deposited over the matrix of nanotubes 12, so that in conjunction with a thin film 14 deposited on the substrate 11 (see below), the matrix of nanotubes 12 may be sandwiched between the coating 13 and the thin film 14. In another approach, the coating 13 may be co-deposited onto the substrate 11 along with the matrix of nanotubes 12. These various embodiments are provided hereinafter in detail.

To the extent desired, the system 10 may further include a thin film 14 disposed between the substrate 11 and the matrix of nanotubes 12 to enhance retention of the matrix of nanotubes 12 on the substrate 11. The thin film 14, in an embodiment, may be deposited onto the substrate 11 by electrolysis. Moreover, similar to coating 13, thin film 14, in one embodiment, may also be made from a metallic material, for instance, Pd or its alloys, such as PdAg, PdRh, among others, or a combination thereof. Any material that can provide a robust coating, that does not chip off easily, and/or that has hydrogen solubility and diffusivity to permit subsequent migration of hydrogen into the nanotubes can also be used to form thin film 14.

As for the hydrogen to be loaded in the system 10 of the present invention, any hydrogen isotope, for instance, hydrogen (H, its nucleus consists of a single proton), deuterium (D, its nucleus has one neutron in addition to one proton) and/or tritium (T, its nucleus has two neutrons in addition to one proton) may be used.

The system 10 of the present invention, in one embodiment, may be manufactured using a variety of protocols. One approach employed in connection with the present invention is provided below.

### SWCNT Preparation

In one embodiment, the SWCNT used in connection with the system 10 of the present invention can be carbon nanotubes provided with a purity of about 95%. However, it should be noted that purity of at least about 50% can be employed. Each of these carbon nanotubes may also include a diameter of about 1.1 nm (nanometer) and a length ranging from about 2 μm to about 20 μm (micrometer). Such carbon nanotubes can be obtained commercially under the name HiPco™ Bucky™ tubes Single Wall Carbon Nanotubes manufactured by Carbon Nanotechnologies Incorporated in Houston, Tex.

To enhance the purity of the nanotubes for the use with the present invention, the nanotubes may be treated in order to open the nanotubes, i.e., removing from the interior of the nanotubes amorphous carbon, organic molecules, bounded water, remains of catalysts, and/or other impurities, so as to create a substantially clear interior or pathway from one end of the nanotube to an opposite end. In an embodiment, 50 mg (milligram) of SWCNT powder was etched (i.e., treated) in about 98% concentrated nitric acid (HNO₃) over a period of about two hours at 300 K. This suspension of SWCNT in HNO₃ was then diluted by about 20-50 times with distilled water, after which the SWCNT were filtered across paper filters, such as those commercially available from Whatman Filter Paper, catalogue No. 1004/50, with multiple washing by distilled water. Thereafter, these filtered SWCNT were slightly dried in atmospheric air at ambient conditions, so that a final suspension of a gel-like consistency can be provided for subsequent application onto a Pd substrate.

### Substrate and Thin Film Preparation

In an embodiment, a 50 μm Pd substrate with a purity of about 99.95% and an area of about 5×1 cm² was used. Such a substrate, in one embodiment, may be obtained from Alfa Aesar GmbH & Co KG in Karlsruhe, Germany. To remove oil traces from its surface, the substrate was etched in concentrated nitric acid (HNO₃) for about 10 minutes. Next, the substrate was subjected to anodic polarization in an electrolytic cell containing 100 ml of 1 M NaOH solution in H₂O. The electrolysis was carried out at a current density of j=20 mA/cm² for about 3-5 minutes. The Pd substrate was then washed with distilled water.

In an embodiment, a thin film or layer of Pd was deposited on top of the substrate by an electrochemical technique. In particular, the substrate was subjected to cathodic polarization in a water solution of 0.1 M HCl to which PdCl₂ (4-8 gram/liter) had been added. The electrolysis was performed at a current density of j=10 mA/cm² for about 3-6 min.

This procedure resulted in the deposition of a thin film or layer of Pd having a thickness of from about 0.25 μm to about 0.3 μm across the surface of the Pd substrate. In an embodiment, depending on the application, such a thin film or layer may have a thickness ranging from about 0.1 μm to about 1.0 μm, and may be in a range of from about 0.3 μm to about 0.6 μm. In addition, the thin film may have a density of from about 0.3 mg/cm² to about 0.4 mg/cm². This density, however, can range from about 0.1 mg/cm² to about 1.0 mg/cm² depending on the use. According to an embodiment of the present invention, the thin film of Pd may be deposited on both sides of the substrate. Of course, should it be desired, the thin film of Pd may be deposited only on one side of the substrate.

### SWCNT Deposition and Coating Application

In order to deposit the matrix of SWCNT on both sides of the Pd substrate 11 coated with the thin film 14 of Pd, the Pd substrate 11, in accordance with one embodiment, was dipped in the SWCNT-H₂O suspension that was previously prepared as described above. The dipping was performed so that the weight of the resulting SWCNT matrix on each side of the Pd substrate may be in the range of from about 1.0 mg to about 2.5 mg. The Pd substrate, along with the applied SWCNT matrix, was then dried for about 2 days at an elevated temperature of from about 30° C. to about 40° C.

Once dried, the SWCNT matrix on each surface of the Pd substrate was then encapsulated (i.e., covered) by a thin coating or layer of Pd using an electrodeposition procedure similar to that described above to provide a composite layer of Pd-SWCNT-Pd on each of the surfaces of the Pd substrate. Specifically, the electrodeposition procedure was carried out in an electrolytic cell containing about 100 ml of 1 M NaOH solution in H₂O at a current density of j=20 mA/cm² for about 3-5 minutes. In one embodiment, the encapsulating coating of Pd on top of the SWCNT matrix may have a thickness ranging from about 0.5 μm to about 0.7 μm. However, other thickness ranges may be employed depending on the particular application and the thickness of the matrix of nanotubes 12. It should be appreciated that the electrodeposition process can result in the coating of the nanotubes circumferentially about the outer surfaces of the nanotubes or the sandwiching of the nanotubes between the thin film 14 and the coating 13. In addition, the electrodeposition of the coating 13 on to the matrix of nanotubes 12 can lead to the deposition of the coating into the spaces between the nanotubes.

To the extent that removal of residual hydrogen from each or either of the composite layers of Pd-SWCNT-Pd may be desired before being used, the Pd substrate having the Pd-SWCNT-Pd composite layer thereon (i.e., system 10) may be annealed at about 400° C. in vacuum set at about 10⁻⁵ torr for about 2 hours.

### Alternative SWCNT Deposition Procedures

### Acetone

As an alternative approach to the above, the SWCNT suspension may initially be dipped in acetone, instead of water, with a burette and subsequently applied onto the Pd substrate. In one embodiment, from about 40 wt % to about 50 wt % of the suspension may be provided in acetone. By employing this approach, a substantially more uniform matrix of SWCNT may be deposited on to the surface of the Pd substrate. In addition, a more accurate amount, in weight, of nanotubes may be provided on the Pd substrate using this approach.

### Electrophoresis Technique

In accordance with another embodiment, SWCNT may be electro-chemically deposited on to each surface of the Pd substrate using an electric field generated by electrolysis (e.g., double electric layer on an interface between the particles and electrode). In particular, the SWCNT may initially be suspended in a water electrolyte (about 0.1-1.0 M HCl). The Pd substrate, serving as a second cathode and covered with electrodeposited thin film of Pd, may then be placed in the middle of the electrolytic cell containing the suspended SWCNT, and between a pair of platinum (Pt) electrodes serving as a cathode and an anode. An electrolysis current with a density of about 10-30 mA/cm² may next be applied while the suspension is being stirred, for instance, with magnetic stirrer. By using this approach, a substantially uniform electrophoretic deposition of SWCNT may be provided on both surfaces of the Pd substrate. In addition, adhesion of the SWCNT to the substrate may be enhanced, and aggregation formation of the SWCNT may be minimized.

### Sputtering

Rather than depositing the coating 13 by electrolysis, it may be possible to sputter a coating of Pd on the matrix of SWCNT using a technology similar to that employed in the production of Pd-catalyst on carbon powder. In particular, SWCNT powder may be employed in connection with vacuum sputtering of a Pd (2-10%) thin film to coat SWCNT particles/aggregates. Such a process has been employed in the preparation of Pd-catalyst on carbon powder (carbon powder+1-2% of Pd) routinely used in modern cars to burn CO pollution.

### Co-Deposition

As another alternative, SWCNT may be co-deposited on to the substrate along with a fine powder of Pd approximately 10 nm in size. In an embodiment, SWCNT may be mixed with about 10 wt % of a fine powder of Pd-black. This mixture may subsequently be deposited on to the surface of the Pd substrate having a thin film of Pd thereon. The co-deposition may employ techniques well known in the art, including those disclosed above. By using this co-deposition approach, adhesion of the SWCNT to the Pd substrate, in an embodiment, can be enhanced. In addition, the Pd-black powder can act to coat or encapsulate the outer surface of the SWCNT to minimize aggregation of the SWCNT.

### Applications

Examples of applications of the system of the present invention include hydrogen storage applications and generation of a thermal response. Additionally, the system of the present invention may also be used as a filter for hydrogen purification, and as a catalyst for H₂+O₂ reaction in fuel cells.

### Hydrogen Storage

The system 10 of the present invention provides, in an embodiment, a matrix of SWCNT 12 and a metallic coating 13 on the SWCNT 12, such as Pd, and if desired, a metallic thin film 14, such as that made from Pd, between SWCNT 12 and substrate 11, so that when the system 10 is exposed to hydrogen at an appropriate effective pressure, the hydrogen, including its atomic or ionic form, can be loaded within the nanotubes 12.

### Verification of Hydrogen Loading into SWCNT in Pd-SWCNT-Pd Cathode

As noted above, the resulting Pd substrate-Pd-SWCNT-Pd composite structure (i.e., system 10) may be used, in an embodiment, for high-density hydrogen loading. In order to verify the hydrogen loading capacity of the SWCNT in the system 10 of the present invention, isothermal vacuum desorption experiments were performed using, in an embodiment, a Pd substrate having the Pd-SWCNT-Pd composite layer (test sample) and a control Pd substrate having a Pd—Pd layer without the SWCNT (control sample) for comparison purposes. Four different batches—batch I, batch II, batch III, and batch IV were tested as illustrated in the table below.

For the test sample in batch I, a Pd foil having a thickness of approximately 50 μm, a width of approximately 1 cm, and a length of approximately 5 cm was used as the substrate. Such a substrate provided a working area (i.e., its surface area immersed in the electrolyte during the loading) of about 7.2 cm². A composite layer of Pd-SWCNT-Pd was deposited on the Pd foil using the procedure described above, with approximately 2.74 mg of SWCNT provided on the working area. In connection with this batch, the SWCNT was obtained from Carbon Nanotechnologies Incorporated in Houston, Tex.

For the control sample in batch I, a Pd foil having the same dimensions and from the same source as the Pd foil used in the test sample was employed for the substrate. In addition, substantially similar thin films/layers of Pd were electrodeposited on top of the control Pd substrate to provide a Pd—Pd layer to replicate the Pd-SWCNT-Pd composite layer, in terms of Pd content, but without the matrix of SWCNT. It should be appreciated that the thickness of the Pd—Pd layer, in such an embodiment, equals the combined thickness of the Pd electrodeposited layers before and after applying the carbon nanotubes on the Pd substrate.

For test samples in batches II and III, the preparation procedures for the SWCNT and Pd-SWCNT-Pd were similar to that employed in batch I. However, the SWCNT used had relatively less purity, approximately 90%, each with a diameter of about 1.2 nm, and a length of about 15 micron. These SWCNT were obtained from Helix Materials Solutions, Inc. in Richardson, Tex. The working area on the test samples in batches II and III contained about 2.20 mg of SWCNT, which was less than that employed in batch I.

The control samples in batch II and batch III employed a Pd foil substrate substantially similar to the control sample in batch I and made in a substantially similar manner.

As for the test sample in batch IV, the preparation procedures and SWCNT similar to that employed for the test sample in batches II and III were used. However, unlike batches II and III, the SWCNT in this test sample were not treated with concentrated nitric acid (HNO₃) prior to their deposition on to the Pd foil substrate. As a result, impurities within the interior of these SWCNT were not removed.

Hydrogen loading in each of the test samples and the control samples was subsequently carried out in a special electrolytic cell with separated cathodic and anodic spaces (similar to that illustrated in FIG. 2), in 1 M NaOH electrolyte. Either a test sample or a control sample was used for the cathode. For batch I, hydrogen loading was carried out at a current density of about 5 mA/cm² for a period of about 2.5 h. For batch II, hydrogen loading was also carried out at a current density of about 5 mA/cm² for a period of about 2.5 h. For batch III, hydrogen loading was carried out at a current density of about 10 mA/cm² for a period of about 1.25 h. In batch III, the current density employed was twice as much as that employed in batches I and II, and over half the time period. It should be noted that during this process, the appearance of hydrogen bubbles was visually observed at the surface of the test sample cathodes just after about 40-50 min of electrolysis, an indication of hydrogen loading. For batch IV, hydrogen loading was carried out at a current density of about 5 mA/cm² for a period of about 2.5 h, similar to that for batches I and II.

After the completion of the electrolysis (i.e., hydrogen loading procedure), the test samples and the control samples from each batch were washed with distilled water, slightly dried with filter paper, and immersed in liquid nitrogen. In this way, spontaneous desorption of molecular hydrogen from the cathode can be minimized between the time each sample was removed from the electrolytic cell to the moment each is put into a vacuum chamber of an isothermal desorption (ID) facility for analysis of the hydrogen loading content.

Analysis of the hydrogen content was then carried out for the test sample and control sample from each batch using a vacuum thermal desorption method. The vacuum thermal desorption method, in an embodiment, was performed at a substantially constant temperature of about 400° C. and at a residual pressure of about 4×10⁻⁶ torr using a three-step MacLeod mercury manometer having sensitivity to evolving hydrogen volume in the range of from about 1×10⁻⁴ cm³ to about 95 cm³. It should be noted that in connection with this process, the gas desorbed from the sample was allowed to permeate through an independent Pd membrane heated to about 600° C. In this way, the measured gas pressure was likely only that from hydrogen with other gas impurities substantially eliminated.

The results of hydrogen measurements were recorded and averaged over five loading runs for the test sample and control sample from each batch, and are presented in table 1 below.

TABLE 1

| | Sample | Desorbed H₂ vol. | Effective |
|---|---|---|---|
| Sample | weight [g] | V [cm³] | H/Pd ratio |
| Control Pd′-Pd-Pd′-(I) | 0.2315 | 14.61 ± 0.42 | 0.60 ± 0.05 |
| j = 5 mA/cm², t = 2.5 h | | | |
| Pd-SWCNT-Pd-(I) | 0.2300 | 18.40 ± 0.63 | 0.75 ± 0.07 |
| m(SWCNT) = 2.74 mg | | | |
| j = 5 mA/cm², t = 2.5 h | | | |
| Control Pd′-Pd-Pd′-(II) | 0.1305 | 8.64 ± 0.25 | 0.62 ± 0.04 |
| j = 5 mA/cm², t = 2.5 h | | | |
| Pd-SWCNT-Pd-(II) | 0.1345 | 10.75 ± 0.28 | 0.79 ± 0.05 |
| m(SWCNT) = 2.20 mg | | | |
| j = 5 mA/cm², t = 2.5 h | | | |
| Control Pd′-Pd-Pd′-(III) | 0.1305 | 7.84 ± 0.22 | 0.58 ± 0.05 |
| j = 10 mA/cm², t = 1.25 h | | | |
| Pd-SWCNT-Pd-(III) | 0.1345 | 11.37 ± 0.29 | 0.80 ± 0.05 |
| m(SWCNT) = 2.20 mg | | | |
| j = 10 mA/cm², t = 1.25 h | | | |
| Control Pd′-Pd-Pd′-(IV) | 0.1480 | 9.24 ± 0.23 | 0.59 ± 0.03 |
| j = 5 mA/cm², t = 2.5 h | | | |
| Pd-SWCNT-Pd-(IV) | 0.1550 | 9.48 ± 0.24 | 0.59 ± 0.04 |
| m(SWCNT) = 1.8 mg | | | |
| j = 5 mA/cm², t = 2.5 h | | | |

As can be seen from the table, the test samples containing the SWCNT and the control samples from each of the batches show measurable volumes of desorbed hydrogen. However over the five cathode polarization runs, the average amount of hydrogen desorbed from the test sample in batch I was significantly higher, approximately 25% higher, than that from the control sample in batch I. In addition, the H/Pd loading ratio in the batch I control sample was found to be ˜0.6, which can be expected for low current density electrochemical loading of Pd cathode. On the other hand, the effective loading ratio (i.e., the x=H/Pd ratio calculated while neglecting the nanotubes) in the batch I test sample was found to be relatively higher, ˜0.75, which typically may not be easily achieved with low current density electrolysis, such as that employed herein. (An in situ 4-probe measurements in electrolysis with the Pd-SWCNT-Pd cathodes also show H/Pd≦0.7 as a maximal possible loading at any current density). Thus, assuming that the excess hydrogen volume (18.4−14.61=) 3.79±0.71 cm³ was stored substantially in the 2.74 mg of SWCNT, it was found that the value of SWCNT capacity with respect to hydrogen is about 11.9±2.5 wt %. This corresponds to a H/C (hydrogen/carbon) atom ratio of approximately 1.6.

As for batch II, the test sample, at low current density of j=5 mA/cm² for t=2.5 h resulted in a hydrogen concentration of about 8.43±1.6 wt % with respect to the SWCNT mass. Of interest, in batch III, the test sample loaded at high current density conditions (=10 mA/cm², during t=1.25 h) resulted in a hydrogen loading concentration of about 13.92±2.0 wt %. The increase in hydrogen loading concentration with batch III show that increase in current density, at the same integral charge transfer to the cathode, can lead to an increase in hydrogen loading. The mechanism for this effect may be attributed to higher degree chemisorption in SWCNT at higher hydrogen flux inside the test sample. Accordingly, it may be desirable to further increase the current density to enhance the hydrogen loading.

For batch IV, the test sample and control sample were both exposed to a current density of j=5 mA/cm² for t=2.5 h. However, unlike the other batches wherein the test samples had open SWCNT, the test sample in batch IV, with the impurities within the SWCNT not removed, did not result in a hydrogen loading concentration that was measurably different than that observed in the control sample in batch IV. Specifically, there was substantially no or very little hydrogen loading in the test sample in batch IV when compared to the control sample in batch IV, as well as those other test samples in batches I-III. The results in batch IV thus illustrate that hydrogen loading is likely to be occurring within the nanotubes rather than between adjacent nanotubes or at the interface between the outer surface of the nanotubes and the Pd thin film.

As noted above, the H/C ratio of about 1.6 experimentally obtained in batch I corresponds to concentration of about 7.5×10²² hydrogen atoms per gram of SWCNT. For comparison, the mass concentration of hydrogen in Pd at a maximum possible loading of H/Pd=1 would only be 5.66×10²¹ per gram Pd. In fully loaded titanium hydride (TiH₂), the hydrogen concentration may be about 1.3×10²² per gram of Ti. Moreover, in the best capacity advanced metal hydride, for instance, MgH₂, the hydrogen concentration may be about 2.7×10²² per gram Mg. This amount corresponds to a hydrogen loading concentration of about 4 wt % in SWCNT. It is therefore observed that the mass concentration of hydrogen in SWCNT in the system of the present invention is about 3 times higher than in the best metal hydride.

Accordingly, system 10 (i.e., a Pd substrate having the layers of Pd-SWCNT-Pd) of the present invention can be useful for hydrogen storage.

### Generation of Thermal Response

The system 10 of the present invention may also be used for generation of a thermal response, for instance, energy generation.

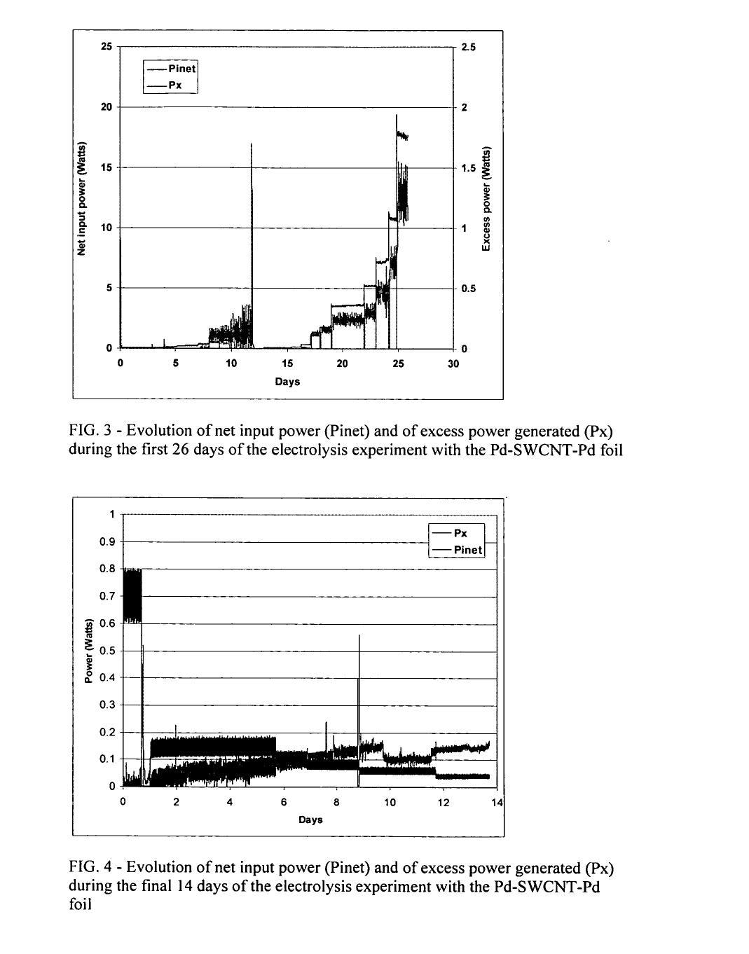

Looking now at FIGS. 3 and 4, there is illustrated a time history of excess heat production or exothermic reactions (i.e., a positive thermal response) in an electrolytic cell experiment using a system of the present invention, and in particular, a cathode made from a Pd substrate with a composite Pd-SWCNT-Pd cathode. The procedure employed, an electrolytic cell designed and constructed by Energetics Technologies, Omer, Israel having two concentric aluminum cylinders with alumina powder thermal insulation in between the cylinders (FIG. 2). The cell included an electrolyte made of about 0.1 to 1 M LiOD in D₂O into which the system of the present invention was immersed. The cell was immersed in a constant temperature water bath set at about 50-10° C. Three sensors were used to monitor the temperature in different locations in the cell. The cell has an external recombiner. A computer was used to collect, store and analyze the experimental data. Temperature readings were done at a rate of 25 scans per second, whereas voltage and current readings were taken at a rate of 50,000 scans per second. The cathode resistance was measured to infer the level of deuterium loading. A LabVIEW program was developed to perform all these functions. The computer was also used to generate a superwave, that is, a superposition of several waves, each of a different frequency and amplitude. This superwave was used to modulate the electrolysis current to drive the process.

This procedure, including the electrolytic cell and its superwaves mode of operation, is described in I. Dardik, T. Zilov, H. Branover, A. El-Boher, E. Greenspan, B. Khachatorov, V. Krakov, S. Lesin and M. Tsirlin, “Excess Heat In Electrolysis Experiments At Energetics Technologies,” Condensed Matter Nuclear Science, October 2004, which is hereby incorporated herein by reference.

As illustrated in FIG. 3, during the first seven or so days of the experiment, there was little or no thermal response. However, presence of a thermal response was observed around the eighth day when the input power was increased. Of note, when the input power was dropped to zero on or about the twelfth day, the thermal response dropped back to zero. The thermal response appeared again at around the seventeenth day as the input power was increased, and kept increasing reaching a value of approximately 1.25 watts when the input power was around 18 watts.

As shown in FIG. 4, during the last couple of weeks of the experiment, the input power was gradually reduced, while a positive thermal response kept increasing. For the last few days, the thermal response even exceeded the level of the input power.

In addition, by time integrating the thermal response over the duration of the experiment, it was determined that the total thermal response generated was approximately 295 kJ during the first 24 days, and approximately 105 kJ during the last 14 days of the experiment. The combined value of 400 kJ corresponds to heat generation of approximately 28 keV per carbon atom in the SWCNT of the cathode or 3 keV per palladium atom in the substrate and in the SWCNT coating. This is approximately 4 orders of magnitude larger than the thermal energy that can be released by any chemical process that the carbon of the SWCNT can undergo, and about 3 orders of magnitude larger than the thermal response that may be released by any chemical reaction the palladium can undergo.

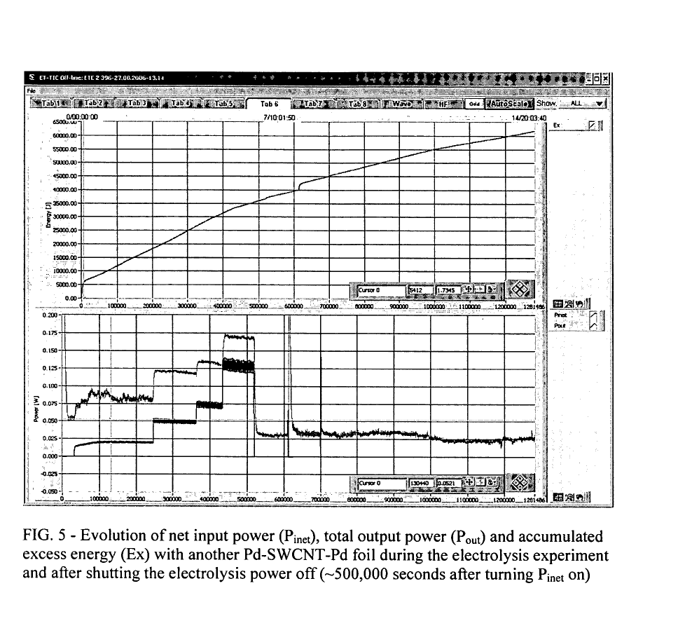

With reference now to FIG. 5, there is illustrated a time history of a thermal response in another electrolytic cell experiment using a system of the present invention. In this experiment, the Pd-SWCNT-Pd cathode used is substantially similar to that used in batch II (described above). Shown in the bottom part of FIG. 5 is the net input power (Pᵢₙₑₜ) and the output power (Pₒᵤₜ), with the excess power being the difference between Pₒᵤₜ and Pᵢₙₑₜ. It is seen that Pₒᵤₜ significantly exceeds Piᵢₙₑₜ throughout the period over which the electrolysis current is applied—that is during the first 500,000 seconds or so from when the current is activated. For example, in the period between 100,000's (100 Ks) and 200 Ks, Pₒᵤₜ is larger than about 75 mW whereas Pᵢₙₑₜ is lower than about 25 mW. After turning off the electrolysis power (Pᵢₙₑₜ) completely, that is, approximately 500 Ks after turning the power on, exothermic reaction leading to a thermal response continues to be observed at a Pₒᵤₜ level of approximately 25 mW.

The observed presence of a thermal response during electrolysis may be due to a flux of hydrogen directed from the electrolyte into the matrix of nanotubes where an environment conducive to an exothermic reaction that can lead to a thermal response may be provided. The observed thermal response subsequent to the reduction of electrolytic current to zero, however, may be due to a flux of hydrogen directed into the matrix of nanotubes from the Pd substrate acting as a hydrogen reservoir. In particular, during electrolysis, the flux of hydrogen as it moves across the nanotubes, may be directed toward the Pd substrate, which has capacity for storage of hydrogen. Over time, the Pd substrate may become loaded with the hydrogen (e.g., deuterium) from the flux of hydrogen. Upon termination of the electrolysis, the hydrogen in the Pd substrate can diffuse in an opposite direction, from the Pd substrate, and into the nanotubes where an environment exists for an exothermic reaction that can lead to a thermal response. Since the Pd substrate can be substantially thick relative to the thickness of the SWCNT layer, the Pd substrate may act as a hydrogen reservoir for the release of hydrogen. As such, the presence of a thermal response may continue long after reduction or termination of the electrolytic current.

### Hydrogen Purification/Filtration

The present invention also provides a system for hydrogen purification or filtration. In particular, the coating of Pd about the matrix of SWCNT or within which the matrix of SWCNT is embedded can allow substantially high purity hydrogen to migrate into the SWCNT, since Pd can be substantially transparent to hydrogen while not as transparent to the atoms/molecules of other gases.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

For example, although materials capable of providing hydrogen storage have been referenced, it should be noted that materials not capable of storing hydrogen nor have the capacity for hydrogen storage at a relatively high density may nevertheless be used as a substrate, since the ability to store hydrogen in the SWCNT may not be affected by the storage properties of the substrate material. However, the ability to generate a thermal response after reduction or termination of the electrolytic current or another external hydrogen flux driving force may be sensitive to the substrate material. In particular, since the amount of hydrogen that can be loaded into such a substrate may be less than that available in a Pd substrate, the flux of hydrogen from such a substrate through the SWCNT upon reduction or termination of an external hydrogen flux driving force may be less. Despite such a decrease in the flux, a thermal response may nevertheless be achieved.

Moreover, despite the low quantity of hydrogen in the Pd coating, a desirable flux of hydrogen through the nanotubes can nevertheless be achieved over a long duration, by, in an embodiment, oscillating the effective pressure to which the outer surface of the coated SWCNT may be exposed. Oscillating the effective hydrogen pressure can be achieved, in one embodiment, by oscillating the current density (e.g., applied voltage) of the electrolysis in an electrolytic cell containing hydrogenous electrolyte, or of the hydrogen gas pressure in a gas-loading device, for instance, from at least about 100 mTorr to about 10 atmosphere, depending on the application. Upon establishment of an appropriate effective pressure on the surface of the coated SWCNT, a hydrogen flux into the SWCNT may be achieved. On the other hand, when there is a reduction in the hydrogen pressure on the surface of the coated SWCNT, the flux of hydrogen may be reversed toward the outward direction from within the SWCNT.

Furthermore, although high hydrogen storage capacity may be provided as one feature of the substrate, it may be possible to use substrates having limited hydrogen storage capacity but sufficiently high hydrogen permeability. By supporting the SWCNT on such a substrate, and applying an appropriate effective pressure on the exposed (i.e. non-supported) surface of the coated SWCNT, while maintaining a relatively low hydrogen pressure on the side of the substrate not supporting the SWCNT, it may be possible to load the nanotubes with hydrogen while establishing a flux of hydrogen in a single direction. This arrangement can be implemented both in electrolytic cells and in a gas loading cells. For example, a permeating supporting structure can be a perforated membrane.

Moreover, to the extent that the SWCNT can be made mechanically self-supporting, the use of a substrate may not be necessary. Nanotubes other than those made from carbon may also be used in connection with the present invention. For instance, nanotubes made from boron nitride may be employed.

It is also intended that any other advantages and objects of the present invention that become apparent or obvious from the detailed description or illustrations contained herein are within the scope of the present invention.

What is claimed is:

1. A system for loading of hydrogen, the system comprising:
a substrate;
a matrix of nanotubes disposed on the substrate, so as to provide an environment for which hydrogen can be directed into the nanotubes; and
a coating deposited over the matrix of nanotubes, the coating made from a material having hydrogen solubility and diffusivity to permit subsequent migration of hydrogen into the nanotubes.

2. A system as set forth in claim 1, wherein the substrate is made from a material including metal, metal alloy, solids, or any combination thereof.

3. A system as set forth in claim 2, wherein the material is an electrically conductive material

4. A system as set forth in claim 1, wherein the substrate is made from a material having capacity for hydrogen storage.

5. A system as set forth in claim 4, wherein the material can adsorb and desorb hydrogen relatively quickly.

6. A system as set forth in claim 1, wherein the substrate has as affinity to palladium and its alloy.

7. A system as set forth in claim 1, wherein the substrate is made from a material including Pd, Cu, Ag, Ti, Mg, Zr, their alloys, or a combination thereof.

8. A system as set forth in claim 1, wherein the matrix of nanotubes includes carbon nanotubes.

9. A system as set forth in claim 8, wherein the carbon nanotubes include single wall carbon nanotubes.

10. A system as set forth in claim 1, wherein the matrix of nanotubes permits movement of hydrogen across the nanotubes.

11. A system as set forth in claim 10, wherein the matrix of nanotubes permits retention of hydrogen within the nanotubes at room temperature.

12. A system as set forth in claim 10, wherein the matrix of nanotubes permits hydrogen to be desorbed therefrom at temperature greater than room temperature.

13. A system as set forth in claim 1, wherein the matrix of nanotubes has a purity of at least 50%.

14. A system as set forth in claim 1, wherein the coating material having hydrogen solubility and diffusivity can act to dissociate hydrogen molecules into their atomic and ionic forms.

15. A system as set forth in claim 1, wherein the coating is made from an electrically conductive material.

16. A system as set forth in claim 1, wherein the coating is made from a material including Pd, PdAg, PdRh, other alloys of Pd, or a combination thereof.

17. A system as set forth in claim 1, wherein the coating has thickness ranging from about 0.1 μm to about 1.0 μm.

18. A system as set forth in claim 1, wherein the coating is disposed upon or circumferentially about the nanotubes.

19. A system as set forth in claim 1, further including a thin film disposed between the substrate and the matrix of nanotubes, so as to enhance retention of the matrix of nanotubes on the substrate.

20. A system as set forth in claim 19, wherein the thin film in conjunction with the coating act to sandwich the matrix of nanotubes between the coating and the thin film.

21. A system as set forth in claim 19, wherein the thin film is made from a material permeable to hydrogen.

22. A system as set forth in claim 19, wherein the thin film is made from an electrically conductive material.

23. A system as set forth in claim 19, wherein the thin film is made from a material including Pd, PdAg, PdRh, other alloys of Pd, or a combination thereof.

24. A method of manufacturing a system for loading of hydrogen, the method comprising:
providing a substrate;
applying a matrix of nanotubes on to the substrate, such that the matrix can provide an environment for which hydrogen can be directed into the nanotubes; and
depositing, onto the matrix of nanotubes, a coating made from a material having hydrogen solubility and diffusivity to permit subsequent migration of hydrogen into the nanotubes.

25. A method as set forth in claim 24, wherein the step of providing includes etching the substrate in an acid to remove traces of oil from the substrate.

26. A method as set forth in claim 24, wherein the step of providing includes subjecting the substrate to electrolysis in a solution having a base compound.

27. A method as set forth in claim 24, wherein, in the step of providing, the substrate is made from a material having capacity for hydrogen storage.

28. A method as set forth in claim 24, wherein, in the step of providing, the substrate is made from a material including Pd, Cu, Ag, Ti, Mg, Zr, their alloys, or a combination thereof.

29. A method as set forth in claim 24, wherein the step of applying includes one of dipping, electrochemical deposition, sputtering, and co-deposition.

30. A method as set forth in claim 24, wherein, in the step of applying, the matrix of nanotubes has a purity of at least 50%.

31. A method as set forth in claim 24, wherein the step of depositing includes performing electrochemical deposition in a solution having an acid compound.

32. A method as set forth in claim 24, wherein, in the step of depositing, the coating made from a material having hydrogen solubility and diffusivity can act to dissociate hydrogen molecules into their atomic and ionic forms.

33. A method as set forth in claim 24, wherein, in the step of depositing, the coating is made from a material including Pd, PdAg, PdRh, other alloys of Pd, or a combination thereof.

34. A method as set forth in claim 24, wherein the step of depositing includes disposing the coating circumferentially about the nanotubes.

35. A method as set forth in claim 24, further including disposing a thin film between the substrate and the matrix of nanotubes, so as to enhance retention of the matrix of nanotubes on the substrate.

36. A method as set forth in claim 35, wherein, in the step of disposing, the thin film in conjunction with the coating act to sandwich the matrix of nanotubes between the coating and the thin film.

37. A method as set forth in claim 35, wherein the step of disposing includes performing electrochemical deposition in a solution having an acid compound.

38. A method as set forth in claim 35, wherein, in the step of disposing, the thin film is made from a material including Pd, PdAg, PdRh, other alloys of Pd, or a combination thereof.

39. A method as set forth in claim 35, wherein the step of disposing includes providing a thin film with a thickness ranging from about 0.1 μm to about 1.0 μm.

40. A method of generating a hydrogen flux, the method comprising:
providing a matrix of nanotubes covered with a coating of a material having hydrogen solubility and diffusivity to permit subsequent migration of hydrogen into the nanotubes;
exposing the coated matrix of nanotubes to hydrogen in an environment having an appropriate effective pressure; and
permitting the hydrogen to move across the coating in the presence of the pressure, so as to generate a flux of hydrogen into the nanotubes.

41. A method as set forth in claim 40, wherein the step of providing includes removing impurities from within the nanotubes, so as to provide a substantially clear interior.

42. A method as set forth in claim 40, wherein the step of providing includes using single wall carbon nanotubes (SWCNT).

43. A method as set forth in claim 40, wherein the step of providing includes supporting the matrix of nanotubes on a substrate.

44. A method as set forth in claim 40, wherein the step of exposing includes subjecting the coated matrix of nanotubes to a current density sufficient to maintain the hydrogen flux.

45. A method as set forth in claim 40, wherein the step of exposing includes subjecting the coated matrix of nanotubes to a gas pressure sufficient to maintain the hydrogen flux.

46. A method as set forth in claim 40, wherein in the step of exposing includes subjecting, for a predetermined period of time, the coated matrix of nanotubes to hydrogen in an environment having an oscillating current.

47. A method as set forth in claim 40, wherein the step of permitting includes allowing the flux of hydrogen to move across the nanotubes.

48. A method as set forth in claim 40, wherein the step of permitting includes allowing the hydrogen moving across the coating to dissociate into its atomic and ionic forms.

49. A method for hydrogen loading, the method comprising:
providing a matrix of nanotubes covered with a coating made from a material having hydrogen solubility and diffusivity to permit subsequent migration of hydrogen into the nanotubes;
generating a flux of hydrogen across the coating and into the nanotubes; and
retaining the hydrogen within the nanotubes while the hydrogen approaches loading capacity of the nanotubes.

50. A method as set forth in claim 49, wherein the step of providing includes removing impurities from within the nanotubes, so as to provide a substantially clear interior.

51. A method as set forth in claim 49, wherein the step of providing includes using single wall carbon nanotubes (SWCNT).

52. A method as set forth in claim 49, wherein the step of providing includes supporting the coated matrix of nanotubes on a substrate.

53. A method as set forth in claim 49, wherein the step of generating includes subjecting, for a predetermined period of time, the coated matrix of nanotubes to hydrogen in an environment having an appropriate effective pressure.

54. A method as set forth in claim 49, wherein the step of generating includes subjecting, for a predetermined period of time, the coated matrix of nanotubes to hydrogen in an environment having one of an oscillating current or an oscillating gas pressure.

55. A method as set forth in claim 49, wherein the step of generating includes subjecting the matrix of nanotubes to one of a current density or a gas pressure sufficient to maintain the hydrogen flux.

56. A method as set forth in claim 49, wherein the step of generating includes allowing the hydrogen moving across the coating to dissociate into its atomic and ionic forms.

57. A method as set forth in claim 49, wherein, in the step of retaining, the loading capacity of the nanotubes is at least 4 wt %.

58. A method as set forth in claim 49, wherein, in the step of retaining, the loading capacity of the nanotubes is about 10 wt % or more.

59. A system for generation of thermal response, the system comprising:
a substrate;
a matrix of nanotubes disposed on the substrate;
a coating deposited over the matrix of nanotubes, the coating made from a material having hydrogen solubility and diffusivity to permit subsequent migration of hydrogen into the nanotubes; and
an amount of hydrogen provided within the nanotubes, so as to provide an environment conducive to exothermic reaction leading to a thermal response.

60. A system as set forth in claim 59, wherein the substrate is an electrically conductive material.

61. A system as set forth in claim 59, wherein the substrate is made from a material having capacity for hydrogen storage.

62. A system as set forth in claim 59, wherein the substrate has as affinity to palladium and its alloys.

63. A system as set forth in claim 59, wherein the substrate is made from a material including Pd, Cu, Ag, Ti, Mg, Zr, their alloys, or a combination thereof.

64. A system as set forth in claim 59, wherein the matrix of nanotubes includes carbon nanotubes.

65. A system as set forth in claim 59, wherein the matrix of nanotubes permits movement of hydrogen across the nanotubes.

66. A system as set forth in claim 59, wherein the coating, made from a material having hydrogen solubility and diffusivity, can act to dissociate hydrogen molecules into their atomic and ionic forms.

67. A system as set forth in claim 59, wherein the coating is made from a material including Pd, PdAg, PdRh, other alloys of Pd, or a combination thereof.

68. A system as set forth in claim 59, wherein the coating is made from an electrically conductive material.

69. A system as set forth in claim 59, further including a thin film disposed between the substrate and the matrix of nanotubes, so as to enhance retention of the matrix of nanotubes on the substrate.

70. A system as set forth in claim 59, wherein the thin film is made from a material permeable to hydrogen.

71. A system as set forth in claim 59, wherein the thin film is made from an electrically conductive material.

72. A system as set forth in claim 59, wherein the thin film is made from a material including Pd, PdAg, PdRh, other alloys of Pd, or a combination thereof.

73. A method for generating thermal response, the method comprising:
providing a matrix of nanotubes covered with a coating of a material having hydrogen solubility and diffusivity to permit subsequent migration of hydrogen into the nanotubes;
generating a flux of hydrogen across the coating and into the nanotubes;
permitting, in the presence of hydrogen, an exothermic reaction to occur within the nanotubes to provide a thermal response.

74. A method as set forth in claim 73, wherein the step of providing includes removing impurities from within the nanotubes, so as to provide a substantially clear interior.

75. A method as set forth in claim 73, wherein the step of providing includes using single wall carbon nanotubes (SWCNT).

76. A method as set forth in claim 73, wherein, in the step of providing, the nanotubes include an amount of hydrogen retained therein.

77. A method as set forth in claim 73, wherein the step of generating includes subjecting, for a predetermined period of time, the coated matrix of nanotubes to hydrogen in an environment having an appropriate effective pressure.

78. A method as set forth in claim 73, wherein the step of generating includes subjecting, for a predetermined period of time, the coated matrix of nanotubes to hydrogen in an environment having one of an oscillating current or an oscillating gas pressure.

79. A method as set forth in claim 73, wherein the step of generating includes subjecting the matrix of nanotubes to one of a current density or a gas pressure sufficient to maintain the hydrogen flux.

80. A method as set forth in claim 73, wherein the step of generating includes allowing the hydrogen moving across the coating to dissociate into its atomic and ionic forms.

81. A method as set forth in claim 73, wherein the step of generating includes retaining the hydrogen within the nanotubes.

82. A method as set forth in claim 73, further including, prior to the step of generating, supporting the matrix of nanotubes on a substrate made from a material having capacity for hydrogen storage.

83. A method as set forth in claim 82, further including allowing the flux of hydrogen to diffuse through the nanotubes and into the substrate.

84. A method as set forth in claim 82, further including:
permitting hydrogen from the substrate to diffuse into the nanotubes; and
providing, in the presence of hydrogen, an environment within the nanotubes for an exothermic reaction leading to a thermal response.
